(19) United States
(12) Patent Application Publication
(10) Pub. No.: US 2016/0298779 A1
(43) Pub. Date: Oct. 13, 2016

(54) AUXILIARY FLOW PREVENTION MECHANISM FOR AN AIR VALVE IN A PIPELINE

(71) Applicant: DOROT MANAGEMENT CONTROL VALVES LTD., Kibbutz Dorot (IL)

(72) Inventor: Asaf Heiman, Moshav Lachish (IL)

(21) Appl. No.: 15/036,165

(22) PCT Filed: Nov. 11, 2014
(86) PCT No.: PCT/IL2014/050979

§ 371 Date: May 12, 2016

Related U.S. Application Data
(60) Provisional application No. 61/903,408, filed on Nov. 13, 2013.

(51) Int. Cl. F16K 24/04

(52) U.S. Cl. CPC F16K 24/044

(57) ABSTRACT

Auxiliary flow prevention mechanism for preventing leakage from the outlet of an air valve due to a seal malfunction of a primary stopper disposed in a primary conduit of a piping system. The mechanism includes an auxiliary conduit coupled downstream of the primary conduit. The mechanism further includes an auxiliary stopper housed within the auxiliary conduit. The auxiliary stopper is configured to seal an outlet of the auxiliary conduit when the primary stopper is in a sealing position but fails to prevent fluid outflow from an outlet of the primary conduit, whereby after sufficient fluid fills the air valve, the resultant increased fluid level urges the auxiliary stopper into a sealing position to seal an outlet of the auxiliary conduit, preventing fluid outflow therefrom. A visual indication of the seal malfunction is provided by a valve or pressure sensor that detects the presence of fluid in a downstream conduit section.

### FIELD OF THE INVENTION

The present invention generally relates to air valves of pipeline systems.

### BACKGROUND OF THE INVENTION

During normal operation of a pipeline system, and especially a sewage pipeline system, it is necessary to allow air to enter and to exit the pipeline while preventing the fluids from being discharged. Typically, such pipeline systems are equipped with at least one type of air valve, for selectively releasing and/or admitting air into a section of the pipeline. Under normal conditions, when little to no fluid is present in the conduit, an air valve enables the unobstructed passage of gases through a conduit in which the air valve is situated. When a certain amount of fluid has collected within the conduit, the air valve rises within the conduit and forms a hermetic seal that prevents the fluid from passing through. An “air release valve”, also known as an “automatic valve”, is a type of air valve that includes a small orifice for venting out small quantities of air (and other gases) under high pipeline pressures. The accumulation of air in the conduit may impede effective fluid flow through the pipeline, and may also result in pressure surges. An “air & vacuum valve”, also known as a “kinetic valve”, is another type of air valve that includes a larger orifice which selectively opens to allow entry or exit of air (and other gases) at a high flow rate during lower pressure differentials. In particular, the air & vacuum valve discharges air when fluid accumulates within the conduit, and the air & vacuum valve admits air when fluid is being drained from the conduit and/or if the internal pressure drops below atmospheric pressure, in order to prevent destructive vacuum conditions in the conduit. A “combination air valve” combines the functionalities of both an air release valve and an air & vacuum valve.

An air valve is normally constructed of one or more sealing mechanisms attached to one or more floats positioned within the valve chamber. When the fluid level in the valve chamber is lowered, the weight of the float causes it to drop, thereby opening the attached sealing mechanism and allowing gas flow through the valve. When the fluid fills the valve chamber, the buoyancy of the float causes the float to rise with the fluid level, which in turn closes the sealing mechanism and prevents fluid flow out of the valve body.

Over time, the sealing mechanism portion of an air valve tends to deteriorate or become damaged, which may impair its sealing capabilities. In general, faulty sealing may result from physical deterioration or material fatigue (e.g., wear and tear in the seal plug), chemical erosion (e.g., due the chemical composition of the fluid or gas passing through the valve), and/or the accumulation of dirt and debris inside and around the sealing mechanism. Consequently, a faulty sealing mechanism fails to provide a sufficiently hermetic seal when the air valve is in a closed or sealed position, which may lead to leakage of the fluids from the conduit. For example, an air release valve may become ineffective due to the gradual accumulation of internal debris, which can prevent the air release valve from fully closing after alleviating high pressure buildups, resulting in an opening which would allow fluid to leak through in unintended scenarios. In many cases, the leaked fluid includes toxic or waste material such as sewage or effluent, or potentially harmful chemical substances. Such a leakage is usually not clearly visible from a distance, and typically would remain undetected for a long period, and consequently remain untreated.

Reference is now made to FIG. 1, which is a schematic illustration of a combination air valve, referenced 100, with a faulty seal, in accordance with prior art. Combination air valve 100 includes a stopper 120 with a faulty sealing mechanism 130. As a result, fluid contained within the chamber 115 leaks out through sealing mechanism 130 when it is in a sealing position, forming a leakage 135 through the conduit outlet.

One possible approach for dealing with a faulty air valve sealing mechanism is to connect a bypass tube or pipe to the conduit outlet. Such a bypass tube serves to transfer the leaked fluid to a different (and less harmful) location, thus ensuring that the leakage is restricted to a selected region.

### SUMMARY OF THE INVENTION

In accordance with one aspect of the present invention, there is thus provided an auxiliary flow prevention mechanism for preventing leakage from the outlet of an air valve due to a seal malfunction of a primary stopper disposed in a primary conduit of a piping system. The auxiliary flow prevention mechanism includes an auxiliary conduit and an auxiliary stopper. The auxiliary conduit is coupled downstream of the primary conduit. The auxiliary stopper is housed within the auxiliary conduit. The auxiliary stopper is configured to seal an outlet of the auxiliary conduit when the primary stopper is in a sealing position but fails to prevent fluid outflow from an outlet of the primary conduit, whereby after sufficient fluid fills the air valve, the resultant increased fluid level urges the auxiliary stopper into a sealing position to seal an outlet of the auxiliary conduit, preventing fluid outflow therefrom. The auxiliary conduit may be coupled to the primary conduit via an intermediate conduit. The auxiliary flow prevention mechanism may further include an indicator, configured to provide an indication of when the primary stopper is in a sealing position but fails to prevent fluid outflow from the outlet of the primary conduit. The indicator may include a valve disposed at a conduit section downstream of the primary conduit, the valve configured to rise when fluid is present within the conduit section. The indicator may further include a pressure sensor, disposed at a conduit section downstream of the primary conduit, the pressure sensor configured to detect increased pressure at the conduit section. The auxiliary flow prevention mechanism may further include a telemetry unit, configured to detect and record telemetry data of the piping system. The telemetry data may include: pressure levels, contamination levels, and/or the types of gases or fluids present in at least one conduit of the piping system. The auxiliary flow prevention mechanism may further include a communication link, configured to transmit the telemetry data to an external location. The auxiliary conduit of the auxiliary flow prevention mechanism may be integrated as a single unit with the primary conduit.

In accordance with another aspect of the present invention, there is thus provided a method for preventing leakage from the outlet of an air valve due to a seal malfunction of a primary stopper disposed in a primary conduit of a piping system. The method includes the procedure of providing an auxiliary conduit coupled downstream of the primary conduit. The method further includes the procedure of providing an auxiliary stopper housed within the auxiliary conduit, the auxiliary stopper configured to seal an outlet of the auxiliary conduit when the primary stopper is in a sealing position but fails to prevent fluid outflow from an outlet of the primary conduit, whereby after sufficient fluid fills the air valve, the resultant increased fluid level urges the auxiliary stopper into a sealing position to seal an outlet of the auxiliary conduit, preventing fluid outflow therefrom.

### BRIEF DESCRIPTION OF THE DRAWINGS

The present invention will be understood and appreciated more fully from the following detailed description taken in conjunction with the drawings in which:

FIG. 1 is a schematic illustration of a combination air valve with a faulty seal, in accordance with prior art;

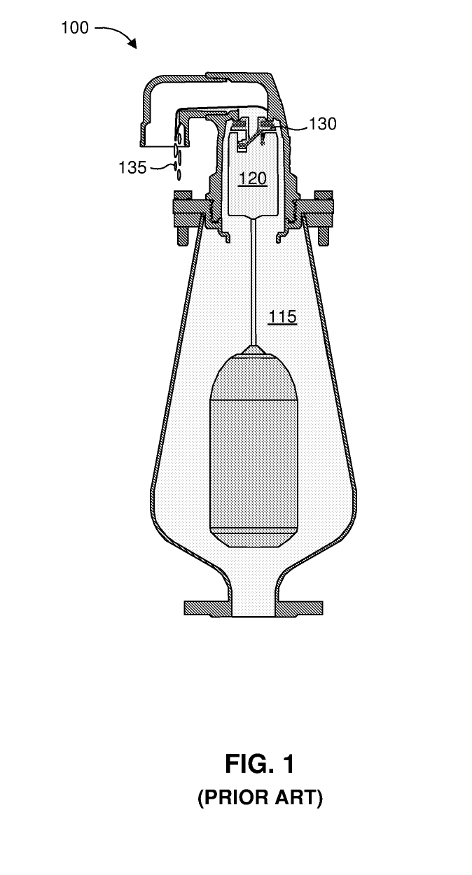

FIG. 2A is a sectional view schematic illustration of an auxiliary flow prevention mechanism operating in conjunction with a faulty air valve in a pipeline system, constructed and operative in accordance with an embodiment of the present invention;

FIG. 2B is a close-up sectional view schematic illustration of a of the auxiliary flow prevention mechanism of FIG. 2A; and

FIG. 3 is a schematic illustration of an auxiliary flow prevention mechanism operating in conjunction with a faulty air valve in a pipeline system, constructed and operative in accordance with another embodiment of the present invention.

### DETAILED DESCRIPTION OF THE EMBODIMENTS

The present invention overcomes the disadvantages of the prior art by providing an auxiliary flow prevention mechanism for an air valve in a pipeline system, to prevent leakage in case of a faulty sealing mechanism of the air valve. The auxiliary flow prevention mechanism includes an auxiliary stopper situated downstream of a primary stopper, which is operational to seal an auxiliary conduit of the pipeline when the primary stopper fails to properly seal a primary conduit of the pipeline. The auxiliary flow prevention mechanism further provides an indication of such faulty sealing, and may also provide a notification to a remote station, to allow for processing and analysis of the malfunction and the possible implementation of a suitable correctional action.

The term “air valve” is used throughout this disclosure to encompass all categories of air valves, including but not limited to “air release valves”, “air & vacuum valves” and/or “combination air valves”, as defined hereinabove. Accordingly, the present invention is applicable to be used in conjunction with any type of valve that includes some form of sealing mechanism that is liable to undergo deterioration or damage which may result in degraded sealing capabilities and potential leakage therefrom. It is appreciated that the term “air valve” as used herein generally refers to the overall assembly that includes various components associated with such air valves (e.g., floats, stoppers, levers, gaskets, washers, O-rings, seal plugs, and the like).

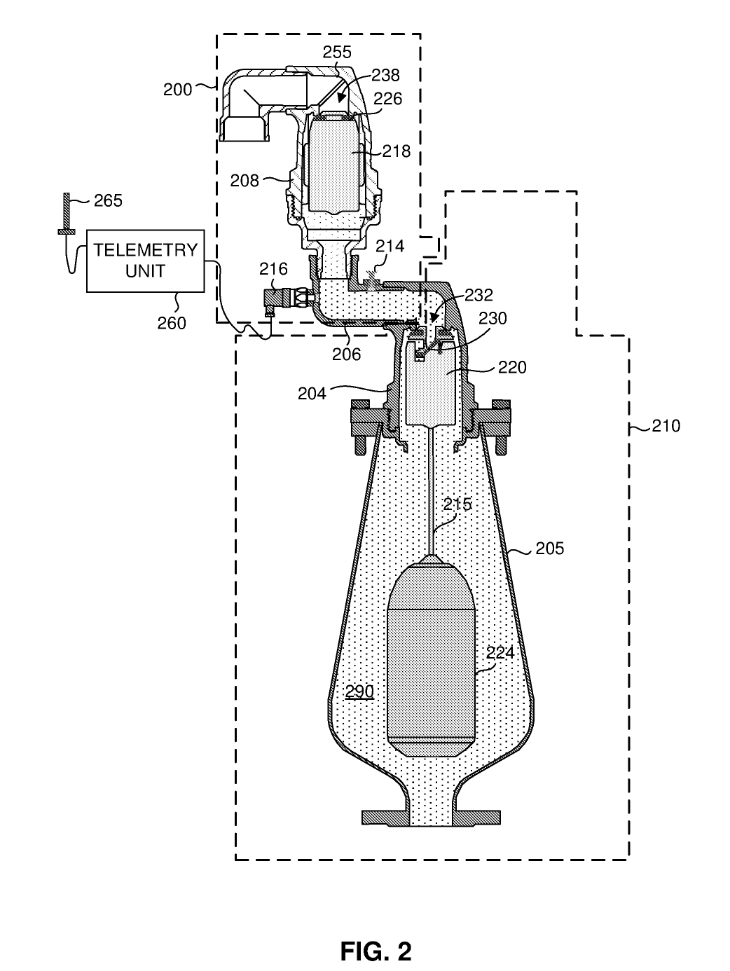

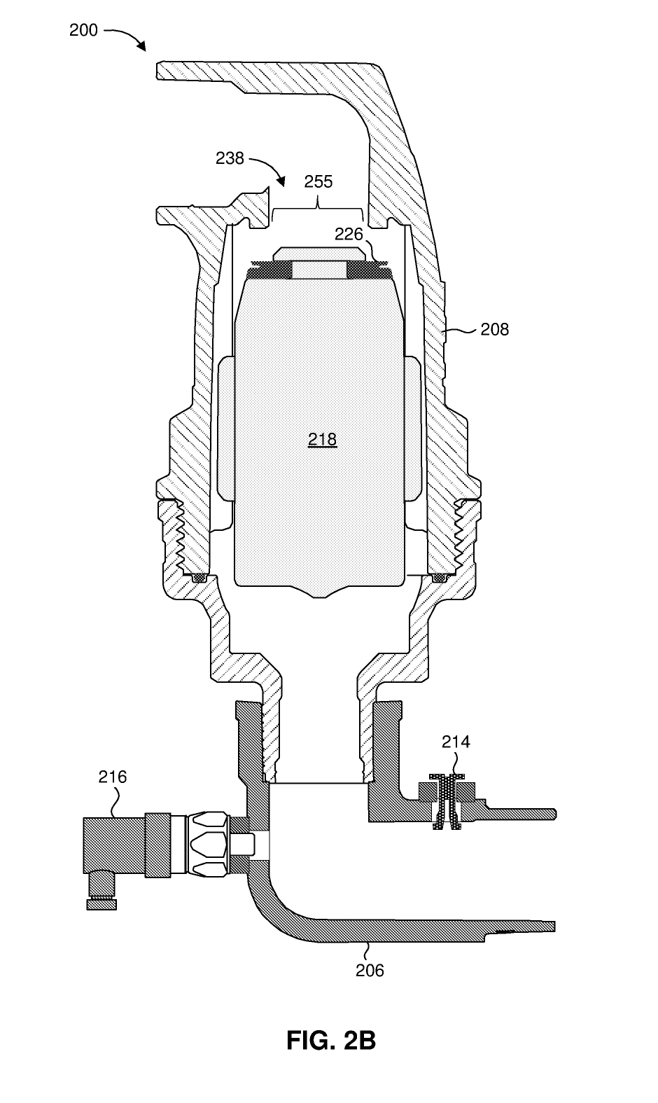

Reference is now made to FIGS. 2A and 2B. FIG. 2A is a sectional view schematic illustration of an auxiliary flow prevention mechanism, generally referenced 200, operating in conjunction with a faulty air valve, generally referenced 210, in a pipeline system, constructed and operative in accordance with an embodiment of the present invention. FIG. 2B is a close-up sectional view schematic illustration of the auxiliary flow prevention mechanism 200 of FIG. 2A. Air valve 210 includes a conical-shaped chamber 205 disposed in a primary conduit 204 of the pipeline system. Air valve 210 includes a float 224 disposed within the body of chamber 205. Air valve 210 further includes a primary stopper 220 coupled to float 224 via a shaft 215, such that primary stopper 220 is situated at a downstream portion of the primary conduit 204, e.g., above float 224. Primary stopper 220 includes a sealing mechanism 230, such as a gasket or a seal plug. Sealing mechanism 230 is operative for selectively sealing off an outlet port 232 of primary conduit 204 when primary stopper 220 is advanced upward toward outlet port 232.

Auxiliary flow prevention mechanism 200 includes an auxiliary conduit 208 coupled downstream of an intermediate conduit 206 that is coupled downstream of primary conduit 204. For example, auxiliary conduit 208 is situated above intermediate conduit 206 and primary conduit 204 in the pipeline system, and exits out to the external atmosphere (i.e., the outlet end of auxiliary conduit 208 is not joined to another component). Auxiliary flow prevention mechanism 200 includes an auxiliary stopper 218 housed within auxiliary conduit 208. Auxiliary stopper 218 includes a sealing mechanism 226, operative for selectively sealing off an outlet port 238 of auxiliary conduit 208 when auxiliary stopper 218 is advanced toward an upper neck portion 255 of auxiliary conduit 208. Auxiliary flow prevention mechanism 200 further includes optional indication and notification components, which include pressure valve 214, pressure sensor 216, telemetry unit 260 and transmitter 265. Pressure valve 214 and pressure sensor 216 are each situated along intermediate conduit 206, generally in between primary stopper 220 and auxiliary stopper 218. Telemetry unit 260 is coupled with pressure sensor 216. Transmitter 265 is coupled with telemetry unit 260.

As fluid 290 fills the chamber 205 of air valve 210, the buoyant float 224 rises upward with the fluid, which propels sealing mechanism 230 to close off outlet port 232 in order to prevent the fluid 290 inside chamber 205 from exiting primary conduit 204. However, sealing mechanism 230 of air valve 210 is faulty or malfunctioning, such that it fails to provide a sufficient sealing of outlet port 232 when in a closed position. Sealing mechanism 230 may be in a faulty state as a result of degradation over time, for example, due to physical deterioration, material fatigue, chemical erosion, and/or the accumulation of debris inside and around sealing mechanism 230. Since the integrity of sealing mechanism 230 is compromised, fluid 290 may detrimentally leak out of primary conduit 204. The leaking fluid 290 exits primary conduit 204 through outlet port 232 and eventually enters intermediate conduit 206 followed by auxiliary conduit 208. The rising fluid level in auxiliary conduit 208 cause auxiliary float 218 to rise upwards and seal off outlet port 238 of auxiliary conduit 208, preventing the leaked fluid 290 from exiting further downstream. The pressure in the now sealed flow prevention mechanism 200 eventually equalizes with the pressure in air valve 210. When auxiliary float 218 enters upper neck portion 255, a seal is formed at outlet port 238. Sealing mechanism 226 of auxiliary stopper 218 is generally composed of a suitable material to ensure a firm and robust seal, such as silicon, rubber, and the like. Optionally, sealing mechanism 226 may be incorporated or integrated, at least partially, with outlet port 238 of auxiliary conduit 208.

Pressure valve 214 is operative to protrude from intermediate conduit 206 when a sufficient amount of fluid is present in intermediate conduit 206. In particular, pressure valve 214 shifts into a raised position due to the increase in fluid pressure when leaking fluid 290 enters intermediate conduit 206, thereby providing a visual indication of the presence of leaked fluid in intermediate conduit 206, and thus an indication of a faulty sealing of air valve 210. Pressure valve 214 may be a bright color, such as yellow, red, or orange, in order to provide a highly conspicuous visual indication. Similarly, pressure valve 214 may be sized and/or shaped in such a way as to be easily visible when in a raised position. Such a conspicuous visual indication serves to quickly notify and alert the relevant operators or maintenance personnel regarding the faulty air valve, and allows for the execution of a rapid response and corrective action. Furthermore, pressure valve 214 may be implemented in a simple and straightforward manner with few mechanical parts, resulting in a lower likelihood of malfunctioning.

Pressure sensor 216 detects increased fluid pressure along intermediate conduit 206 and/or auxiliary conduit 208. Telemetry unit 260 collects and records telemetry data, such as: pressure levels, contamination levels, types of gases or fluids present, and the like.

Accordingly, telemetry unit 260 may include various sensors or detectors for measuring the relevant data, as well as associated processing and memory components. Transmitter 265 is configured to transmit the telemetry data to another location, such as a control station associated with the pipeline system in which auxiliary flow prevention mechanism 200 operates. The location may receive telemetry data from a plurality of auxiliary flow prevention mechanisms 200 in accordance with the present invention, which are disposed at different portions of a large-scale piping system, such as a sewage system, in order to obtain an indication of potential problems or malfunctions throughout the entire piping system.

The portions of the piping system indicating a potential issue may then be further explored and addressed if necessary, providing rapid and effective maintenance.

When a low level of fluid is present in chamber 205 of air valve 210, and valve 210 is in an open position (i.e., outlet port 232 of primary conduit 204 is unsealed), there is a low pressure differential between primary conduit 204 and intermediate conduit 206, and also a low pressure differential between intermediate conduit 206 and outlet port 238 of auxiliary conduit 208. Air (and other gases) is able to flow freely between the conduits (204, 206, 208) as primary stopper 220 and auxiliary stopper 218 are both not in a sealing position. In contrast, when a high level of fluid is present in air valve 210, there may be a high pressure differential between primary conduit 204 and intermediate conduit 206, and a low pressure differential between intermediate conduit 206 and outlet port 238 of auxiliary conduit 208. High pressure air (and other gases) may thus discharge through primary stopper 220, specifically through sealing mechanism 230, while primary stopper 220 is in a sealing position. Discharged gases are also able to flow through intermediate conduit 206 as auxiliary stopper 218 is not in a sealing position.

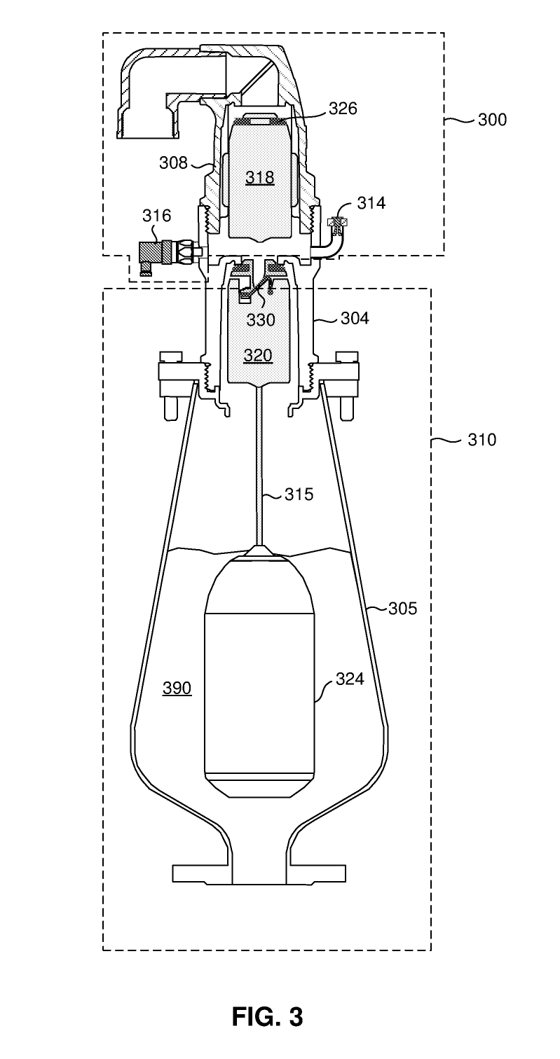

Reference is now made to FIG. 3, which is a schematic illustration of an auxiliary flow prevention mechanism, generally referenced 300, operating in conjunction with a faulty air valve, generally referenced 310, in a pipeline system, constructed and operative in accordance with another embodiment of the present invention. Air valve 310 includes a conical chamber 305 disposed in a primary conduit 304 of the pipeline system. Air valve 310 includes a primary stopper 320 coupled downstream to a float 324 via a shaft 315. Primary stopper 320 includes a sealing mechanism 330, such as a gasket or a seal plug, for selectively sealing off an outlet port of primary conduit 304 when primary stopper 320 is advanced toward the primary conduit outlet port. Auxiliary flow prevention mechanism 300 includes an auxiliary conduit 308 situated downstream and above primary conduit 304, the auxiliary conduit 308 housing an auxiliary stopper 318. Auxiliary stopper 318 includes a sealing mechanism 326, such as a gasket or a seal plug, for selectively sealing off an outlet port of auxiliary conduit 308 when auxiliary stopper 318 is advanced toward the auxiliary conduit outlet port. Auxiliary flow prevention mechanism 300 and air valve 310 are analogous to auxiliary flow prevention mechanism 200 and air valve 210 of FIGS. 2A and 2B, with the exception that auxiliary conduit 308 is coupled directly with primary conduit 304, rather than via an intermediate conduit (such as intermediate conduit 206 of FIG. 2A). In particular, auxiliary conduit 308 is integrated as a single unit with primary conduit 304, such that the outlet of primary conduit 304 feeds directly into the inlet of auxiliary conduit 308. Consequently, the auxiliary flow prevention mechanism (300) configuration of FIG. 3 involves a fewer number of components as compared to the auxiliary flow prevention mechanism (200) configuration of FIGS. 2A and 2B, and hence a lower likelihood of component malfunctioning and greater overall versatility, as well as lower cost for manufacturing. Auxiliary flow prevention mechanism 300 may further include optional indication and notification components, such as pressure valve 314 and pressure sensor 316 (analogous to pressure valve 214 and pressure sensor 216 of FIGS. 2A and 2B), which may be situated along auxiliary conduit 308, such as in between primary stopper 330 and auxiliary stopper 350.

In accordance with an embodiment of the present invention, a method for preventing leakage from the outlet of an air valve due to a seal malfunction of a primary stopper disposed in a primary conduit of a piping system includes the procedures of: providing an auxiliary conduit, coupled downstream of the primary conduit; and providing an auxiliary stopper, housed within the auxiliary conduit and being activated to seal an outlet of the auxiliary conduit when the primary stopper is in a sealing position but fails to prevent outflow from an outlet of the primary conduit, whereby after sufficient fluid fills the air valve, the resultant increased fluid level urges the auxiliary stopper into a sealing position to seal an outlet of the auxiliary conduit, preventing fluid outflow therefrom.

While certain embodiments of the disclosed subject matter have been described, so as to enable one of skill in the art to practice the present invention, the preceding description is intended to be exemplary only. It should not be used to limit the scope of the disclosed subject matter, which should be determined by reference to the following claims.

1. An auxiliary flow prevention mechanism for preventing leakage from the outlet of an air valve due to a seal malfunction of a primary stopper disposed in a primary conduit of a piping system, said mechanism comprising:
an auxiliary conduit, coupled downstream of said primary conduit; and
an auxiliary stopper, housed within said auxiliary conduit, said auxiliary stopper configured to seal an outlet of said auxiliary conduit when said primary stopper is in a sealing position but fails to prevent fluid outflow from an outlet of said primary conduit, whereby after sufficient fluid fills said air valve, the resultant increased fluid level urges said auxiliary stopper into a sealing position to seal an outlet of said auxiliary conduit, preventing fluid outflow therefrom.

2. The auxiliary flow prevention mechanism of claim 1, wherein said auxiliary conduit is coupled to said primary conduit via an intermediate conduit.

3. The auxiliary flow prevention mechanism of claim 1, further comprising an indicator, configured to provide an indication of when said primary stopper is in a sealing position but fails to prevent fluid outflow from said outlet of said primary conduit.

4. The auxiliary flow prevention mechanism of claim 3, wherein said indicator comprises a valve disposed at a conduit section downstream of said primary conduit, said valve configured to rise when fluid is present within said conduit section.

5. The auxiliary flow prevention mechanism of claim 3, wherein said indicator comprises a pressure sensor, disposed at a conduit section downstream of said primary conduit, said pressure sensor configured to detect increased pressure at said conduit section.

6. The auxiliary flow prevention mechanism of claim 1, further comprising a telemetry unit, configured to detect and record telemetry data of said piping system, said telemetry data selected from the list consisting of:
pressure levels in at least one conduit of said piping system;
contamination levels in at least one conduit of said piping system;
types of gases or fluids present in at least one conduit of said piping system; and
any combination thereof.

7. The auxiliary flow prevention mechanism of claim 6, further comprising a communication link, coupled with said telemetry unit, said communication unit coconfigured to transmit said telemetry data to an external location.

8. The auxiliary flow prevention mechanism of claim 1, wherein said auxiliary conduit is integrated as a single unit with said primary conduit.

9. A method for preventing leakage from the outlet of an air valve due to a seal malfunction of a primary stopper disposed in a primary conduit of a piping system, the method comprising the procedures of:
providing an auxiliary conduit, coupled downstream of said primary conduit; and
providing an auxiliary stopper housed within said auxiliary conduit, said auxiliary stopper configured to seal an outlet of said auxiliary conduit when said primary stopper is in a sealing position but fails to prevent fluid outflow from an outlet of said primary conduit, whereby after sufficient fluid fills said air valve, the resultant increased fluid level urges said auxiliary stopper into a sealing position to seal an outlet of said auxiliary conduit, preventing fluid outflow therefrom.
